(19) United States
(12) Patent Application Publication
(10) Pub. No.: US 2021/0061079 A1
(43) Pub. Date: Mar. 4, 2021

(54) BED COVER OF PICKUP TRUCK THAT IS EASY TO OPEN AND CLOSE

(71) Applicant: CHANGZHOU SILAINUO AUTO TECH. LTD, CHANGZHOU (CN)

(72) Inventors: JIAN SUN, CHANGZHOU (CN); BINYAN HE, CHANGZHOU (CN); YIPING MA, CHANGZHOU (CN); MINJIE MA, CHANGZHOU (CN)

(73) Assignee: CHANGZHOU SILAINUO AUTO TECH. LTD

(21) Appl. No.: 16/584,910

(22) Filed: Sep. 26, 2019

(30) Foreign Application Priority Data
Aug. 28, 2019 (CN) 201910799188.3

(51) Int. Cl. B60J 7/14; B60J 7/19

(52) U.S. Cl. CPC B60J 7/141; B60J 7/198

(57) ABSTRACT

This invention is relevant to a bed cover of pickup truck that is easy to open and close. The bed cover of pickup truck includes one bed cover. The bed cover is easy to open and close with simple structure. The invention not only fixes the bed cover in the vertical direction, but also ensures that the container cover does not move forward or backward in the horizontal direction through the mutual cooperation of two locking structure. The bed cover can be opened and closed through the locking structure on both sides. Thus it is convenient to open and close the bed cover.

### CROSS-REFERENCE TO RELATED APPLICATIONS

This application claims priority to Chinese Patent Application No. 201910799188.3 with a filing date of Aug. 28, 2019. The content of the aforementioned applications, including any intervening amendments thereto, are incorporated herein by reference.

### TECHNICAL FIELD

This invention is relevant to mechanical field, especially about the bed cover of pickup truck.

### BACKGROUND TECHNOLOGY

Pickup truck is a car with cab and an open truck compartment. With its comfortable interior environment, charming appearance, strong power, low price and the practicability of both passenger-cargo purpose, pickup truck meets the need of people from all walks of life.

However, pickup trucks have open bed and often need a cover for shelter to prevent the goods in it from sunshine and rain. The disadvantage of existing bed cover of pickup truck is that water will seep into the inside of the rotating shaft in the transfer part. At the same time, when the existing bed cover is opened or closed, it is not easy to disassemble, assemble and adjust. And it is likely for the bed cover to slip forward and backward, Which will affect the effect of dust prevention and water blocking. Therefore customers will feel uncomfortable when using it.

### ABOUT THE INVENTION

The purpose of the invention is to provide a bed cover of pickup truck that is easy to open and close and solve at least one technical problem above.

Thus the invention use the following method:

A bed cover of pickup truck that is easy to open and close includes one bed cover, wherein said bed cover includes at least two plates; two mounting rod installed on the bed cover of pickup truck. And the adjacent plates are connected by rotating shaft structure;

the rotating shaft structure includes a plate-like pedestal, two connectors which form a rotary connection with the pedestal;

there are first grooves on the both sides of the pedestal, and there is a first stop bar on one side of the first groove;

one side of the connectors is connected with the plates. There is a first rotating part arranged in the first groove on the other side of the connectors. The lower surface of the first rotating part is cambered. There is a rotary groove whose cross section is major arc shape in the above part of the first rotary part. And the front part of the second stop bar is in the rotary groove. There exists a second stop bar for clamping the first stop bar on one side of the rotating groove.

The bed cover comprises two locking structure. A long strip-shaped section steel is arranged on the lower surface of the plate, and a strip groove is arranged on the section steel. The two locking structure are respectively arranged on both sides of the strip groove. The two locking structure include a first locking structure and a second locking structure. The two mounting rods include a first and second mounting rod.

The first locking structure comprises a first bolt, a first locking frame, a limit block, a first compression spring and a first handle. The first locking frame is arranged on the first mounting rod. And one side of the first bolt is provided with a first hook for clamping the first locking frame. The first bolt is provided with a first chute. The limit block and the first compression spring are arranged in the first chute. The limit block is fixed to the section steel by bolts. One end of the first compression spring is against the side wall of the first chute. The other end of the first compression spring is against the limit block. Both sides of the first handle are fixed to the section steel by bolts, and the first bolt is provided with the first sheet-shaped convex, which is used as the second handle.

The second locking structure comprises a second bolt, a second locking frame, a mounting base, a second compression spring, and a slide block for pushing the second bolt. The mounting base is fixed to the second mounting rod. The second bolt and the second compression spring are all arranged on the mounting base. A second chute is arranged on both sides of the mounting base, and a cylindrical convex with circular cross section is arranged on both sides of the second bolt. One side of the cylindrical convex extends into the second chute, and one end of the second compression spring is against the inner wall of the mounting base. The other end of the second compression spring is against the second bolt, and both sides of the second locking frame are fixed to the section steel through bolts. The second bolt includes a second hook for clamping the second locking frame. The second lock frame is provided with a second sheet-shaped convex, which is used as the third handle. And the slide block is arranged on one side of the second locking frame. The slide block is arranged in the strip groove. The slide block is provided with a third sheet-shaped convex, which is used as the fourth handle.

The slide block is connected with the first bolt through a wire rope. The cross section of the mounting base is in the shape of a “ [symbol] ”, and one side of the mounting base is fixed to the second mounting rod by bolts.

Both sides of the first bolt and the slide block are provided with a ladder-like groove. The upper part of the two sides of the strip groove is provided with a fourth sheet-shaped convex for the limitation.

The two mounting rods are respectively fixed to the side walls of the pickup truck bed cover through bolts.

The lower surfaces of both sides of the plate body are provided with a ball-end connector, which is fixed to the plate by bolts. A ball-end connecting rod is arranged on the ball-end connector, and the ball head of the ball-end connecting rod is embedded in the ball-end connector. One side of the ball-end connecting rod is provided with a bulk convex, whose cross section is major arc shape.

A third chute is arranged on both mounting rods, and a first slide block is arranged in the third chute. A rotating shaft hole is arranged on the first slide block, and a rotating shaft is arranged at the rotating shaft hole. The rotating shaft is connected with one side of the support rod, and the other side of the support rod is provided with a first slot for clamping the bulk convex. The third chute is provided with a second slide block, and the second slide block is provided with a second slot for clamping the support rod. The cross section of the second slot is major arc shape.

One side of the connectors is provided with the first embedded slot; and the one side of the plate is embedded into the slot.

A sidebar is set in the outside part of the plates to protect the side of the plates, and there is the second embedded slot for the plates set in one side of the sidebar.

A corner socket set in the corner of the plates to connect the adjacent sidebars. And the two ends of the corner socket are provided with a first plug for inserting into the first insert slot.

There is a rotating shaft socket set in outside part of the rotating shaft structure to protect the structure; the rotating shaft socket contains one first socket installed in the outside part of the pedestal and two second sockets installed in the connectors;

there is a second groove on the two sides of the first socket;

one side of the second socket is fixedly connected with the sidebar. The other side of the second socket is provided with a second rotating part which is arranged in the second groove. And the lower surface of the second rotating part is arc-shaped. The upper side of the second rotating part is provided with a drainage channel connected with the rotating groove;

the upper part of the first socket is provided with the fifth sheet-shaped convex to cover the pedestal. And the upper part of the second socket is provided with the sixth sheet-shaped convex to cover the connector.

The second plug for inserting into the first insert slot is arranged on one side of the second socket, and then one side of the second socket is fixedly connected with the side bar.

A second insert slot is arranged on the pedestal and the connector. And a third plug for inserting the second insert slot is arranged on the upper part of the first and second socket.

A first thread bolt hole is arranged on the pedestal and the connector. A second thread bolt hole matching the position of the first thread bolt hole is arranged on the first and the second socket. Then the pedestal is fixed with the first socket, and the connector part is fixed with the second socket by thread bolts.

When the rotating shaft is used, the first stop bar rotates in the rotating slot. When turned to the maximum angle, the first stop bar will be blocked by the second stop bar and its further rotation will be restricted. The connector can rotate from 0° to 95° opposite the pedestal, while the two adjacent plates can rotate 0° to 190° opposite to each other. The rotating range is large. It is very convenient to open the bedcover of the pickup truck when used; The drainage channel in the invention are bigger and will not cause syphonage. Thus the leading function will be better, requirement of the assembly accuracy will be lower and the production will be easier.

When the locking structure is in use, the user can tighten the first locking structure to tighten the first handle and the second handle on one side of the strip groove. And the first bolt will be pulled, then the first hook on the first bolt is detached from the first locking frame. The first bolt drives the slide block to move in the same direction through the wire rope. And The slide block is used to push the second hook that holds the second locking frame so that the second hook is detached from the second locking frame and the cover of the car is opened. Alternatively, the user can tighten the second locking structure to tighten the third handle and the fourth handle on the other side of the strip groove. And the slide block will be pulled. The slide block pushes the second hook that holds the second locking frame to detach from the second locking frame. The slide block drives the first bolt to move in the same direction through the wire rope. Then the first hook on the bolt is separated from the first locking frame, and the cover is opened. The bed cover can be opened and closed through the locking structure on both sides. When closing the cover, tighten the first or the second locking structure and press down the plate. Through the first compression spring, and the second compression spring, the first and the second bolt are pushed respectively. Then the first hook is pushed into and hold the first locking frame. The second hook is pushed into and hold the second locking frame to close the car cover.

This invention provides a bed cover of pickup truck with simple structure and great leading function. At the same time, the invention not only fixes the bed cover in the vertical direction, but also ensures that the container cover does not move forward or backward in the horizontal direction through the mutual cooperation of two locking structure. The bed cover can be opened and closed through the locking structure on both sides. Thus it is convenient to open and close the bed cover and improves the user's experience.

### DESCRIPTION OF DRAWINGS

FIG. 1 is an illustration of the state of use in the invention;

FIG. 2 is a front view of the state of use in the invention;

FIG. 3 is a partial structure illustration in the invention.

FIG. 4 is a partial structure side view in the invention.

FIG. 5 is a cross-sectional illustration of a partial structure in the invention.

FIG. 6 is an illustration of partial structural cross section at the turning parts in the invention.

FIG. 7 is an illustration of partial structural cross section of the pedestal in the invention.

FIG. 8 is an illustration of partial structural cross-section after the combination of the pedestal and turning parts in the invention.

FIG. 9 is a partial structural illustration of the section steel in the invention.

FIG. 10 is a partial structural illustration of the locking structure in the invention.

FIG. 11 is a bottom view illustration of the partial structure in the invention.

FIG. 12 is a partial structure illustration at the rotary shaft joint in the invention.

FIG. 13 is a bottom view at the joint of the rotating shaft in the invention.

### THE CONCRETE METHOD TO CARRY OUT

The following instruction is to further explain t the concrete implementation method of the invention.

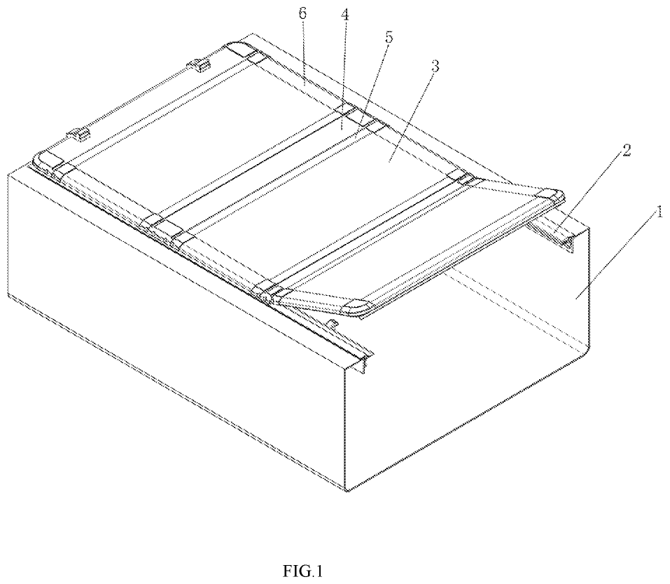

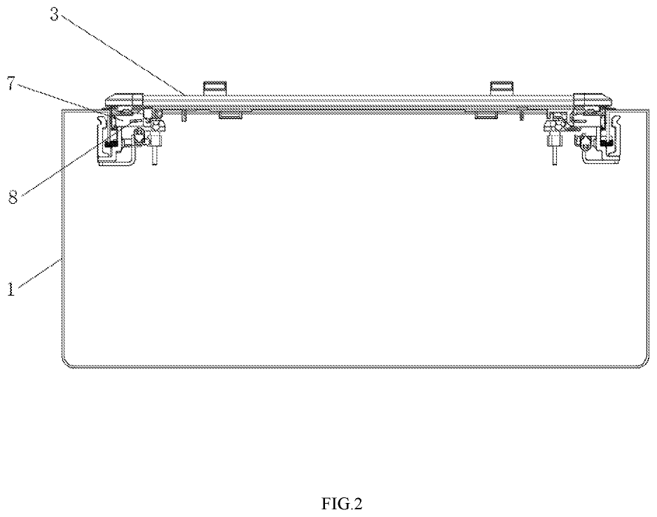

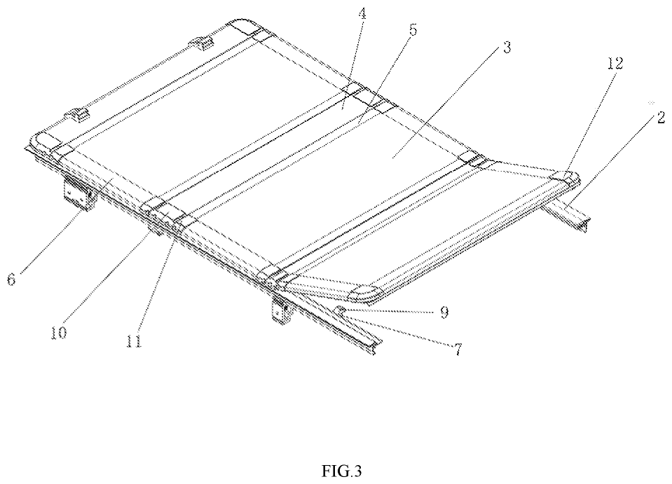

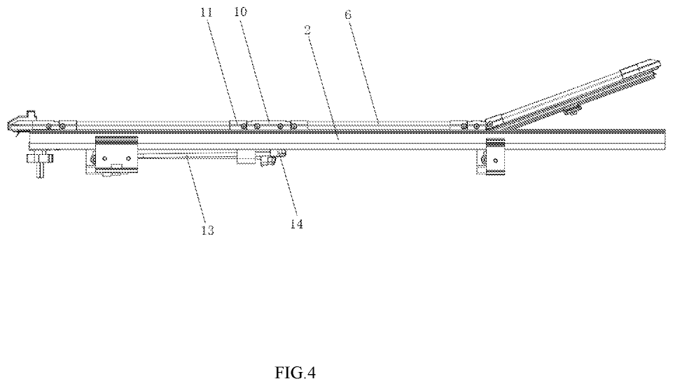

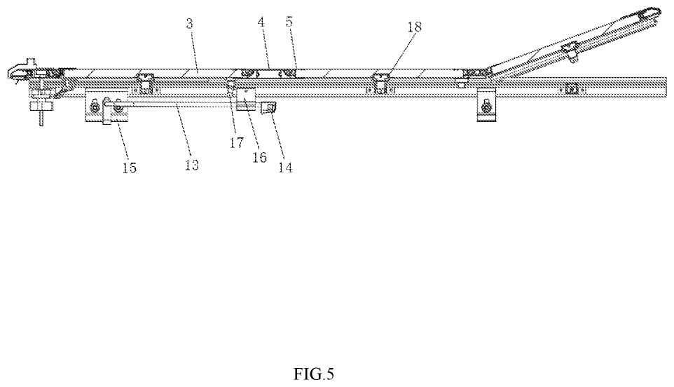

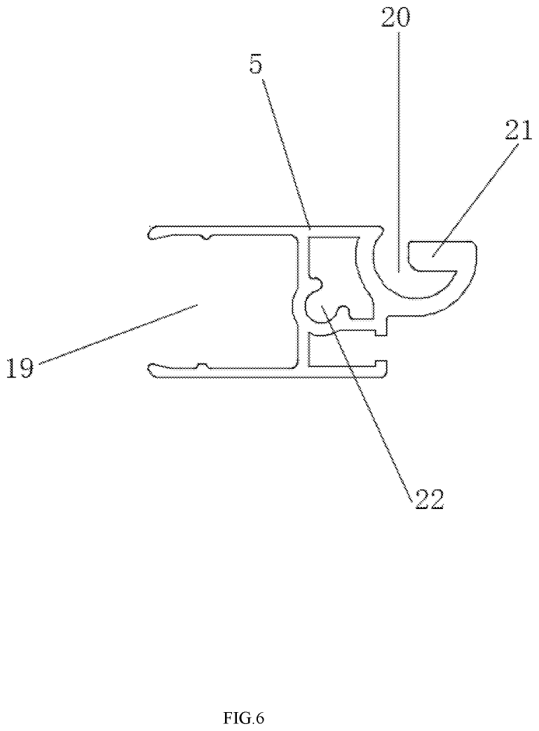

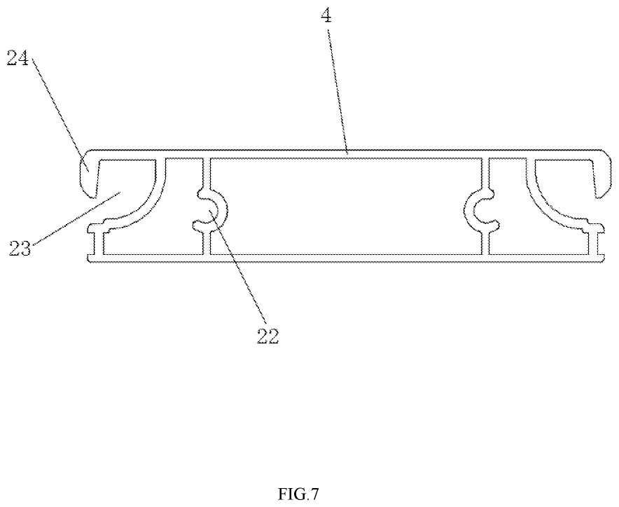

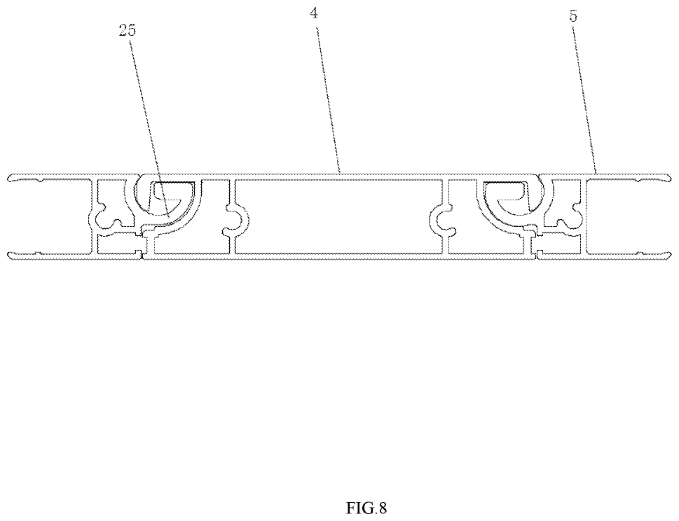

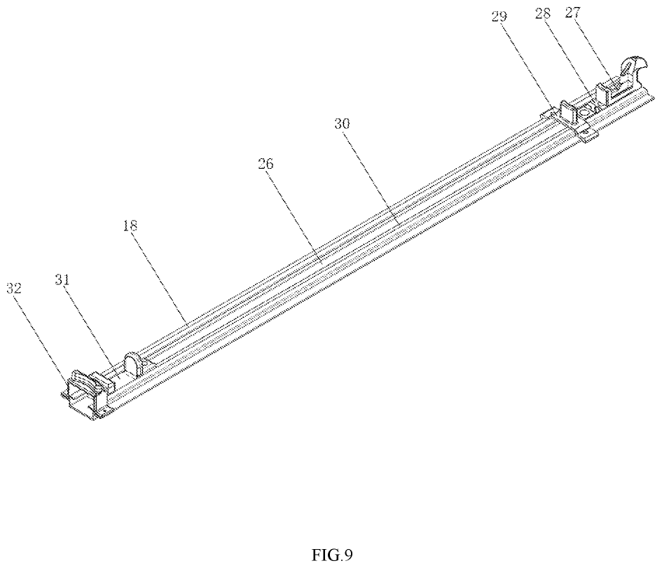

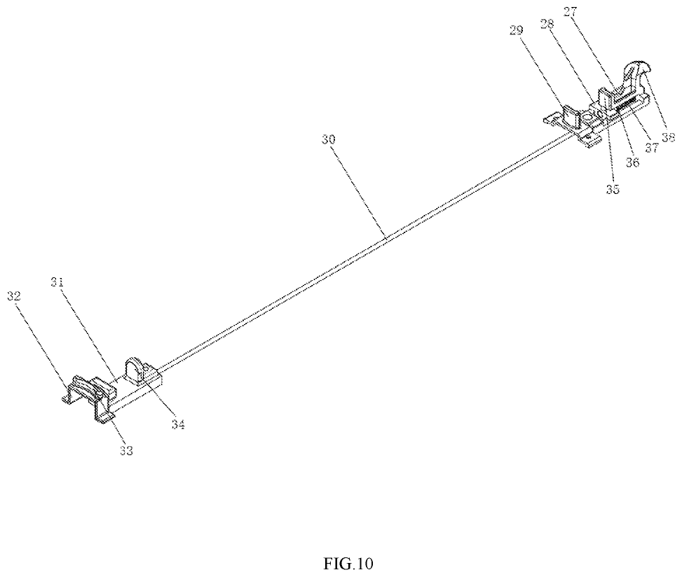

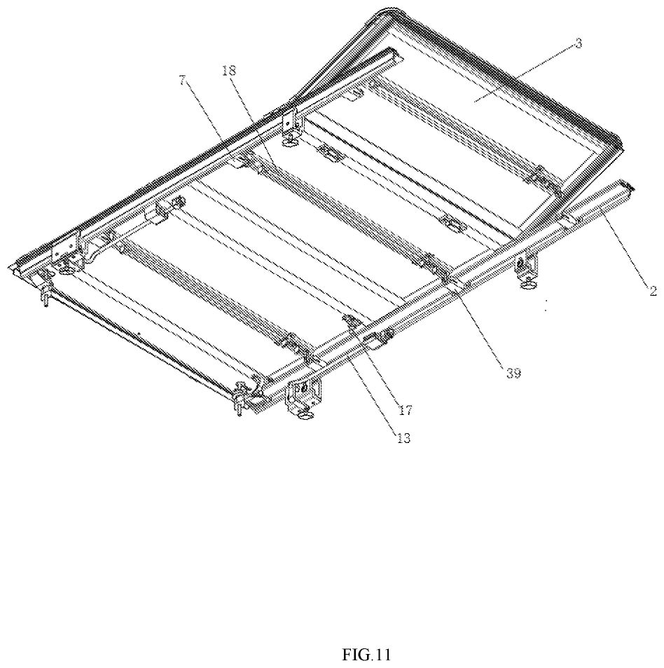

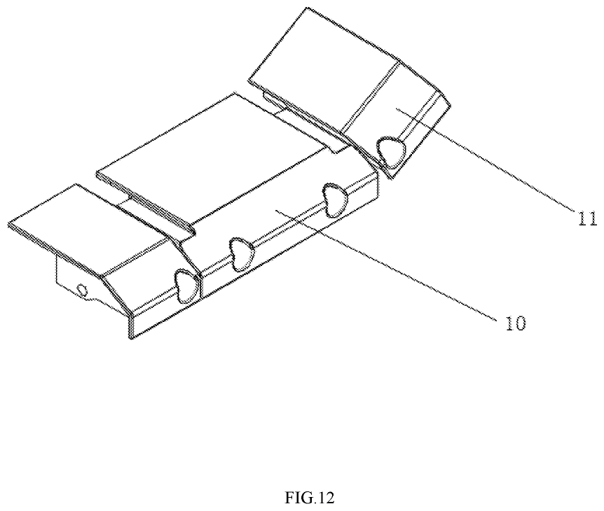

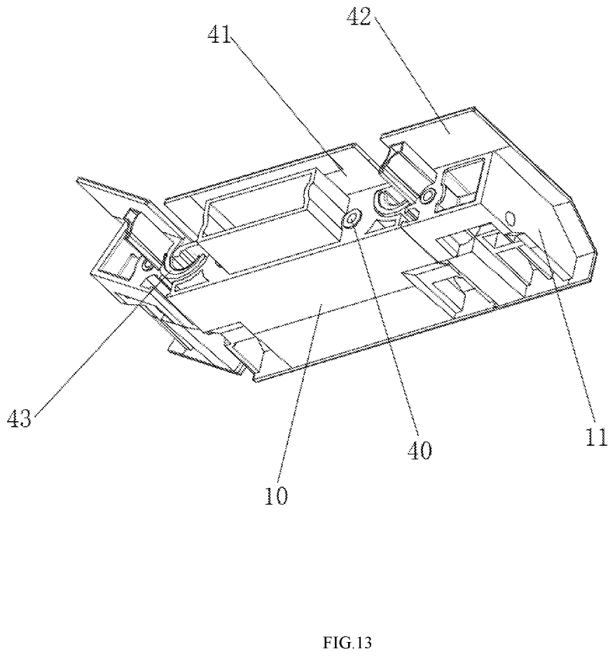

As is seen from FIG. 1 to 13, a bed cover of pickup truck that is easy to open and close includes one bed cover, wherein said bed cover includes at least two plates 3; two mounting rod 2 installed on the bed covert of pickup truck. And the adjacent plates are connected by rotating shaft structure; the rotating shaft structure includes a plate-like pedestal 4, two connectors 5 which form a rotary connection with the pedestal; there are first grooves 23 on the both sides of the pedestal, and there is a first stop bar 24 on one side of the first groove; one side of the connectors is connected with the plates, There is a first rotating part 25 arranged in the first groove on the other side of the connectors. The lower surface of the first rotating part is cambered. There is a rotary groove 20 whose cross section is major arc shape in the above part of the first rotary part. And the front part of the second stop bar is in the rotary groove. There exists a second stop bar 21 for clamping the first stop bar on one side of the rotating groove. The bed cover comprises two locking structure. A long strip-shaped section steel 18 is arranged on the lower surface of the plate, and a strip groove 26 is arranged on the section steel. The two locking structure are respectively arranged on both sides of the strip groove. The two locking structure include a first locking structure and a second locking structure. The two mounting rods include a first and second mounting rod.

The first locking structure comprises a first bolt 27, a first locking frame 39, a limit block 28, a first compression spring 37 and a first handle 29. The first locking frame is arranged on the first mounting rod. And one side of the first bolt is provided with a first hook 38 for clamping the first locking frame. The first bolt is provided with a first chute 36. The limit block and the first compression spring are arranged in the first chute. The limit block is fixed to the section steel by bolts. One end of the first compression spring is against the side wall of the first chute. The other end of the first compression spring is against the limit block. Both sides of the first handle are fixed to the section steel by bolts, and the first bolt is provided with the first sheet-shaped convex, which is used as the second handle 35. The second locking structure comprises a second bolt 9, a second locking frame 32, a mounting base 7, a second compression spring, and a slide block for pushing the second bolt. The mounting, base is fixed to the second mounting rod. The second bolt and the second compression spring are all arranged on the mounting base. A second chute 8 is arranged on both sides of the mounting base, and a cylindrical convex with circular cross section is arranged on both sides of the second bolt. One side of the cylindrical convex extends into the second chute, and one end of the second compression spring is against the inner wall of the mounting base. The other end of the second compression spring is against the second bolt, and both sides of the second locking frame are fixed to the section steel through bolts. The second bolt includes a second hook for clamping the second locking frame. The second lock frame is provided with a second sheet-shaped convex, which is used as the third handle 33. And the slide block is arranged on one side of the second locking frame. The slide block is arranged in the strip groove. The slide block is provided with a third sheet-shaped convex, which is used as the fourth handle 34. The slide block is connected with the first bolt through a wire rope 30. This invention provides a bed cover of pickup truck with simple structure and great leading function. At the same time, the invention not only fixes the bed cover in the vertical direction, but also ensures that the container cover does not move forward or backward in the horizontal direction through the mutual cooperation of two locking structure. The bed cover can be opened and closed through the locking structure on both sides. Thus it is convenient to open and close the bed cover and improves the user's experience.

When the rotating shaft structure is used, the first stop bar rotates in the rotating slot. When turned to the maximum angle, the first stop bar will be blocked by the second stop bar and its further rotation will be restricted. The connector can rotate from 0° to 95° opposite the pedestal, while the two adjacent plates can rotate 0° to 190° opposite to each other. The rotating range is large. It is very convenient to open the bedcover of the pickup truck when used; The drainage channel in the invention are bigger and will not cause syphonage. Thus the leading function will be better, requirement of the assembly accuracy will be lower and the production will be easier.

When the locking structure is in use, the user can tighten the first locking structure to tighten the first handle and the second handle on one side of the strip groove. And the first bolt will be pulled, then the first hook on the first bolt is detached from the first locking frame. The first bolt drives the slide block to move in the same direction through the wire rope. And The slide block is used to push the second hook that holds the second locking frame so that the second hook is detached from the second locking frame and the cover of the car is opened. Alternatively, the user can tighten the second locking structure to tighten the third handle and the fourth handle on the other side of the strip groove. And the slide block will be pulled. The slide block pushes the second hook that holds the second locking frame to detach from the second locking frame. The slide block drives the first bolt to move in the same direction through the wire rope. Then the first hook on the bolt is separated from the first locking frame, and the cover is opened. The bed cover can be opened and closed through the locking structure on both sides. When closing the cover, tighten the first or the second locking structure and press down the plate. Through the first compression spring and the second compression spring, the first and the second bolt are pushed respectively. Then the first hook is pushed into and hold the first locking frame. The second hook is pushed into and hold the second locking frame to close the car cover.

In order to ensure the use effect of the equipment, this design limits the distance of the first bolt being pulled or the slide block being pushed by the limit block. The lower surface of the plate body is provided with an installation groove, where the section steel is embedded. The cross section of the mounting base is in the shape of a “ [symbol] ”, and one side of the mounting base is fixed to the second mounting rod by bolts. The upper surfaces of the first hook and the second hook are arc-shaped. Thus it will be smoother for the first hook to separate from the first locking frame and the second hook will separate from the second locking frame more smoothly as well.

Both sides of the first bolt and the slide block are provided with a ladder-like groove. The upper part of the two sides of the strip groove is provided with a fourth sheet-shaped convex for the limitation. The groove on both sides of the first bolt and the slide block is clamped by the fourth sheet-shaped convex. Then the first bolt and slide block are limited to slide in the strip groove to ensure the use effect.

The two mounting rods are respectively fixed to the side walls of the pickup truck bed cover through bolts, which make it easy to disassemble and install mounting rods through bolts.

The lower surfaces of both sides of the plate body are provided with a ball-end connector, which is fixed to the plate by bolts. A ball-end connecting rod is arranged on the ball-end connector, and the ball head of the ball-end connecting rod is embedded in the ball-end connector. One side of the ball-end connecting rod is provided with a bulk convex 17, whose cross section is major arc shape. A third chute is arranged on both mounting rods, and a first slide block 15 is arranged in the third chute. A rotating shaft hole is arranged on the first slide block, and a rotating shaft is arranged at the rotating shaft hole. The rotating shaft is connected with one side of the support rod 13, and the other side of the support rod is provided with a first slot 14 for clamping the bulk convex. The third chute is provided with a second slide block 16, and the second slide block is provided with a second slot for clamping the support rod. When the support rod is used to support the upside-down plate, the first slide block is slid, the supporting rod is rotated, and the bulk convex is clamped into the first slot. Then the support rod plays the role of supporting the upside-down plate. When the supporting rod is not used, the support rod is rotated so that the support rod and the mounting rod are arranged side by side, and the support rod is clamped and fixed through the second slot.

At least two of the plates are made of FRP Honeycomb Panel. The rotating shaft structure is made of plastic. The pedestal adopts hollow structure to reduce the cost and make it easier to produce.

In order to ensure the structural strength of the equipment, the connectors and the first rotating part, the first rotating part and the second stop bar all adopt the integrated structure. And the pedestal and the first stop bar adopt the integrated structure. The bottom surface of the first groove is arc-shaped to match the lower surface of the first rotating part, which is more smooth when deflected.

One side of the above connectors are provided with the first embedded slot 19. And the one side of the above plate is embedded into the slot. So the above connector is fixedly connected with the plates. The cross section of the first embedded slot is [symbol] shape. The cross section of the first embedded slot is [symbol] shape. And the first embedded slot is provided with at least two opposite first strip convex. The length direction of first convex is the same as that of the connector.

The sidebar 6 is set in the outside part of the plates to protect the side of the plates. And there is the second embedded slot for the plates set in one side of the sidebar. The first insert slot is arranged on both ends of the sidebars. The cross section of the second embedded slot is in the shape of [symbol] . The second embedded slot is provided with at least two opposite arranged second strip convex. And the length direction of the second strip convex is the same as the length direction of the sidebar. The sidebars are used to protect the sides of the plate and reduce the damage caused by collision on the side edges of the plate.

There is a corner socket 12 set in the corner of the plates to connect the adjacent sidebars. The two ends of the corner socket are provided with a first plug for inserting into the first insert slot to connect the sidebars and enhance the installation strength of the sidebar. Using the plate located on the outer side of the bed cover as an example, the first sidebar is arranged on the left side of the plate, the second sidebar is arranged on the front side of the plate. And the third sidebar is arranged on the right side of the plate. Thus the first sidebar will be connected with the second sidebar through the first corner socket, and the second sidebar will be connected with the third sidebar through the second corner socket.

There is a rotating shaft socket set in outside part of the rotating shaft structure to protect the structure. The rotating shaft socket contains one first socket 10 installed in the outside part of the pedestal and two second socket 11 installed in the outside part of connectors; There is the second grooves on both sides of the first socket; one side of the second socket is fixedly connected with the sidebar, And the other side of the second socket is provided with the second rotating part 43. The second rotating part is arranged in the second groove And the lower surface of the second rotating part is arc-shaped. The upper side of the second rotating part is provided with a drainage channel connected with the rotating groove. The water seeping into the rotating groove will flow into the drainage channel and quickly flow through the drainage channel. Thus The invention has better drainage performance. The bottom surface of the second groove is arc-shaped to match the lower surface of the second rotating part. And the second rotating part is more smooth when deflected. An opening on one side of the second groove is used as a drainage port. And the drainage outlet is then arranged on the inner side of the second socket. The drainage outlet which is with hidden form is arranged inside the second socket to avoid additional opening of water outlet and guarantee the overall beauty of the cover. A waterproof gasket is arranged below the first socket and the second socket and an opening is arranged on the waterproof gasket located below the drainage outlet.

The upper part of the first socket is provided with the fifth sheet-shaped convex 41 to cover the pedestal. And the upper part of the second socket is provided with the sixth sheet-shaped convex 42 to cover the connector. The fourth sheet-shaped convex and the first socket, the fifth sheet-shaped convex and the second socket all adopt the integrated structure. The outer part of the plate and the rotating shaft device is covered by the sheet-shaped convex and the side bar thus achieving the waterproof effect.

The second insert slot is arranged on the pedestal and the connector. And a third plug for inserting the second insert slot is arranged on the upper part of the first and second socket. A first thread bolt hole 22 is arranged on the pedestal and the connector. A second thread bolt hole 40 matching the position of the first thread bolt hole is arranged on the first and the second socket. Then the pedestal is fixed with the first socket, and the connector part is fixed with the second socket by thread bolts. The first socket and the pedestal, the second socket and the connector are fixedly connected through plug insertion and bolt screw. Thus they are closely connected, achieve sealing and waterproof effect.

Finally, it should be noted that the above is only a preferred embodiment of the invention and is not used to limit the invention. Although the invention is described in detail with reference to the above embodiment, it is still possible for those skilled in the field to modify. Or they can do equivalent replacement of some of the technical features in it. Any modification, equivalent replacement, improvement etc. made within the spirit and principles of the invention shall be included in the scope of protection of the invention.

We claim:

1. A bed cover of pickup truck that is easy to open and close, wherein said bed cover of pickup truck includes one bed cover; the bed cover includes at least two plates; two mounting rod installed on the bed cover of pickup truck; and the adjacent plates are connected by rotating shaft structure;
the rotating shaft structure includes a plate-like pedestal, two connectors which form a rotary connection with the pedestal;
there are first grooves on the both sides of the pedestal, and there is a first stop bar on one side of the first groove;
one side of the connectors is connected with the plates; there is a first rotating part arranged in the first groove on the other side of the connectors; the lower surface of the first rotating part is cambered; there is a rotary groove whose cross section is major arc shape in the above part of the first rotary part; and the front part of the second stop bar is in the rotary groove; there exists a second stop bar for clamping the first stop bar on one side of the rotating groove;
the bed cover comprises two locking structure; a long strip-shaped section steel is arranged on the lower surface of the plate, and a strip groove is arranged on the section steel; the two locking structure are respectively arranged on both sides of the strip groove; the two locking structure include a first locking structure and a second locking structure; the two mounting rods include a first and second mounting rod;
the first locking structure comprises a first bolt, a first locking frame, a limit block, a first compression spring and a first handle; the first locking frame is arranged on the first mounting rod; and one side of the first bolt is provided with a first hook for clamping the first locking frame; the first bolt is provided with a first chute; the limit block and the first compression spring are arranged in the first chute; the limit block is fixed to the section steel by bolts; one end of the first compression spring is against the side wall of the first chute; the other end of the first compression spring is against the limit block; both sides of the first handle are fixed to the section steel by bolts, and the first bolt is provided with the first sheet-shaped convex, which is used as the second handle;
the second locking structure comprises a second bolt, a second locking frame, a mounting base, a second compression spring, and a slide block for pushing the second bolt; the mounting base is fixed to the second mounting rod; the second bolt and the second compression spring are all arranged on the mounting base; a second chute is arranged on both sides of the mounting base, and a cylindrical convex with circular cross section is arranged on both sides of the second bolt; one side of the cylindrical convex extends into the second chute, and one end of the second compression spring is against the inner wall of the mounting base; the other end of the second compression spring is against the second bolt, and both sides of the second locking frame are fixed to the section steel through bolts; the second bolt includes a second hook for clamping the second locking frame; the second lock frame is provided with a second sheet-shaped convex, which is used as the third handle; and the slide block is arranged on one side of the second locking frame; the slide block is arranged in the strip groove; the slide block is provided with a third sheet-shaped convex, which is used as the fourth handle;
the slide block is connected with the first bolt through a wire rope.

2. The bed cover of pickup truck that is easy to open and close according to claim 1, wherein said cross section of the mounting base is in the shape of a [symbol] , and one side of the mounting base is fixed to the second mounting rod by bolts.

3. The bed cover of pickup truck that is easy to open and close according to claim 1, wherein said both sides of the first bolt and the slide block are provided with a ladder-like groove; the upper part of the two sides of the strip groove is provided with a fourth sheet-shaped convex for the limitation.

4. The bed cover of pickup truck that is easy to open and close according to claim 1, wherein said lower surfaces of both sides of the plate body are provided with a ball-end connector, which is fixed to the plate by bolts; a ball-end connecting rod is arranged on the ball-end connector, and the ball head of the ball-end connecting rod is embedded in the ball-end connector; one side of the ball-end connecting rod is provided with a bulk convex, whose cross section is major arc shape;
a third chute is arranged on both mounting rods, and a first slide block is arranged in the third chute; a rotating shaft hole is arranged on the first slide block, and a rotating shaft is arranged at the rotating shaft hole; the rotating shaft is connected with one side of the support rod, and the other side of the support rod is provided with a first slot for clamping the bulk convex;
the third chute is provided with a second slide block, and the second slide block is provided with a second slot for clamping the support rod.

5. The bed cover of pickup truck that is easy to open and close according to claim 1, wherein said one side of the connectors is provided with the first embedded slot; and the one side of the plate is embedded into the slot.

6. The bed cover of pickup truck that is easy to open and close according to claim 1, wherein a sidebar is set in the outside part of the plates to protect the side of the plates; and there is the second embedded slot for the plates set in one side of the sidebar.

7. The bed cover of pickup truck that is easy to open and close according to claim 6, wherein there is a corner socket set in the corner of the plates to connect the adjacent sidebars;
the two ends of the corner socket are provided with a first plug for inserting into the first insert slot.

8. The bed cover of pickup truck according to claim 1, wherein there is a rotating shaft socket set in outside part of the rotating shaft structure to protect the structure; the rotating shaft socket contains one first socket installed in the outside part of the pedestal and two second sockets installed in the connectors;
there is a second groove on the two sides of the first socket;
one side of the second socket is fixedly connected with the sidebar; the other side of the second socket is provided with a second rotating part which is arranged in the second groove; and the lower surface of the second rotating part is arc-shaped; the upper side of the second rotating part is provided with a drainage channel connected with the rotating groove.

9. The bed cover of pickup truck that is easy to open and close according to claim 8, wherein the upper part of the first socket is provided with the fifth sheet-shaped convex to cover the pedestal; and the upper part of the second socket is provided with the sixth sheet-shaped convex to cover the connector.

10. The bed cover of pickup truck that is easy to open and close according to claim 8, wherein a second insert slot is arranged on the pedestal and the connector; and a third plug for inserting the second insert slot is arranged on the upper part of the first and second socket;
a first thread bolt hole is arranged on the pedestal and the connector; a second thread bolt hole matching the position of the first thread bolt hole is arranged on the first and the second socket.
